(19) United States
(12) Patent Application Publication
(10) Pub. No.: US 2012/0305182 A1
(43) Pub. Date: Dec. 6, 2012

(54) METHOD FOR PRODUCING METAL FOIL LAMINATE

(75) Inventors: Shohei Azami, Tsukuba-shi (JP); Changbo Shim, Tsukuba-shi (JP)

(73) Assignee: SUMITOMO CHEMICAL COMPANY, LIMITED, Chuo-ku, Tokyo (JP)

(21) Appl. No.: 13/497,674

(22) PCT Filed: Sep. 24, 2010
(86) PCT No.: PCT/JP2010/066522

§ 371 Date: Aug. 27, 2012

(30) Foreign Application Priority Data
Sep. 25, 2009 (JP) 2009-220106

(51) Int. Cl. B29C 43/18

(52) U.S. Cl. 156/306.6

(57) ABSTRACT

It is an object of the invention to provide a method for producing a metal foil laminate that can yield a metal foil laminate with a satisfactory outer appearance, while also improving the flatness of the metal foil laminate. As a preferred mode of the method, the method for producing a metal foil laminate comprising metal foils on both sides of an insulating base material, comprises a second stack-preparing step in which a second stack is prepared having a laminar structure wherein a first stack comprising an insulating base material sandwiched between a pair of first metal foils, a pair of first spacers, a pair of second spacers and a pair of first cushion materials in that order, is sandwiched between a pair of metal sheets and a pair of second cushion materials, in that order, and a second stack-hot pressing step in which the second stack is hot pressed with a pair of heating plates in the direction of lamination.

### TECHNICAL FIELD

The present invention relates to a method for producing a metal foil laminate to be used, for example, as a material for a printed circuit board.

### BACKGROUND ART

Electronic devices continue to increase in multifunctionality at an accelerated pace year by year. In order to obtain such multifunctionality, demand is increasing for higher performance in printed circuit boards that mount electronic components, in addition to improvements in semiconductor packages. For example, there is an increasing need for higher densities in printed circuit boards to meet demands for smaller and lighter-weight electronic devices. This has led to advances in multilayering of circuit boards, narrowing of wiring pitches and micronization of via holes.

Metal foil laminate materials used in printed circuit boards have conventionally been produced by laminating an electrical insulating material composed mainly of a thermosetting resin such as a phenol resin or epoxy resin, and a conducting material composed mainly of a metal foil such as a copper foil, using a hot press apparatus or heated roll. Recently, liquid crystal polyesters with excellent heat resistance and electrical characteristics have become an object of interest, and their application to insulating base material sections of metal foil laminates has been attempted, as disclosed in Patent document 1.

For production of such a metal foil laminate, as disclosed in Patent document 2 for example, an insulating base material is inserted between metal foils such as copper foils, the laminate is situated directly between a pair of metal sheets such as SUS sheets, and the pair of upper and lower heating plates of a hot press apparatus are used for hot pressing under reduced pressure.

### CITATION LIST

### Patent Literature

[Patent document 1] Japanese Unexamined Patent Application Publication No. 2007-106107
[Patent document 2] Japanese Unexamined Patent Application Publication No. 2000-263577

### SUMMARY OF INVENTION

### Technical Problem

However, the following problems are associated with the process described above.

Firstly, when the metal sheets used for production of the metal foil laminate are reutilized, their surface condition is generally impaired, with fine irregularities being produced on the surface. Therefore, when such metal sheets are used to produce a metal foil laminate, the irregularities of the metal sheets are transferred to the surface of the metal foil laminate, creating irregularities on the copper foil and impairing the outer appearance of the metal foil laminate. Polishing of the metal sheet surfaces has been considered as a measure aimed at avoiding this problem, but introducing a polishing step has disadvantages in terms of both time and labor, lowering productivity for the metal foil laminate, and therefore this method has not been practical.

Secondly, since the metal sheets are placed directly on the heating plates of the hot press apparatus, the heat transmitted from the heating plates to the metal foil laminate increases, often resulting in overheating. When overheating occurs, the metal foils of the metal foil laminate become oxidized and discolored, potentially causing significant impairment in the outer appearance of the metal foil laminate.

Thirdly, when a metal foil laminate is produced according to the method disclosed in Patent document 2, the hot pressing is carried out with multiple stacked layers of the constituent material comprising a thermoplastic liquid crystal polymer film, a pair of metal foils and a pair of metal plates, and therefore the pressure balance tends to be disturbed. This has resulted in potential irregularities and warping in the obtained metal foil laminate, reducing the flatness of the metal foil laminate.

The present invention has been accomplished under these circumstances, and its object is to provide a method for producing a metal foil laminate that can yield a metal foil laminate with a satisfactory outer appearance, while also improving the flatness of the metal foil laminate.

### Solution to Problem

As a result of diligent research directed toward achieving this object, the present inventors focused on inserting a first spacer, a second spacer and a first cushion material between each first metal foil and each metal sheet composing a metal foil laminate, during production of the metal foil laminate, so that irregularities on the surface of the metal sheet are not transferred to the surface of the metal foil laminate thereby creating irregularities on the first metal foil, and so that the pressure balance is not disturbed, and further on inserting a second cushion material between each heating plate and each metal sheet so that the amount of heat transmitted from the heating plate to the metal foil laminate is not increased thereby resulting in overheating, and the invention has thus been completed.

Specifically, the first invention is a method for producing a metal foil laminate comprising metal foils on both sides of an insulating base material, the method comprising a second stack-preparing step in which a second stack is prepared having a laminar structure wherein a first stack comprising an insulating base material sandwiched between a pair of first metal foils, a pair of first spacers, a pair of second spacers and a pair of first cushion materials in that order, is sandwiched between a pair of metal sheets and a pair of second cushion materials, in that order, and a second stack-hot pressing step in which the second stack is hot pressed with a pair of heating plates in the direction of lamination.

The second invention has the construction of the first invention, wherein during the second stack-hot pressing step, the second stack is hot pressed under reduced pressure.

The third invention has the construction of the first or second invention, wherein the first metal foil is a copper foil.

The fourth invention has the construction of any one of the first to third inventions, wherein the first spacer is a copper foil or SUS foil.

The fifth invention has the construction of any one of the first to fourth inventions, wherein the second spacer is a copper foil or SUS foil.

The sixth invention has the construction of any one of the first to fifth inventions, wherein the metal sheet is an SUS sheet.

The seventh invention has the construction of any one of the first to sixth inventions, wherein the second cushion material is an aramid cushion.

The eighth invention has the construction of any one of the first to seventh inventions, wherein the insulating base material is a prepreg in which a liquid crystal polyester is impregnated into inorganic fibers or carbon fibers.

The ninth invention has the construction of the eighth invention, wherein the liquid crystal polyester has solvent solubility and has a flow start temperature of 250° C. or higher.

The tenth invention has the construction of the eighth or ninth invention, wherein the liquid crystal polyester is a liquid crystal polyester having structural units represented by formula (1), (2) and (3), the content of the structural unit represented by formula (1) being 30-45 mol %, the content of the structural unit represented by formula (2) being 27.5-35 mol % and the content of the structural unit represented by formula (3) being 27.5-35 mol %, with respect to the total content of all of the structural units.

—O—Ar¹—CO— (1)

—CO—Ar²—CO— (2)

—X—Ar³—Y— (3)

(In the formulas, Ar¹ represents a phenylene or naphthylene group, Ar² represents a phenylene or naphthylene group or a group represented by formula (4), Ar³ represents a phenylene group or a group represented by formula (4), and X and Y each independently represent O or NH. The hydrogens of the groups represented by Ar¹, Ar² and Ar³ may each independently be replaced by halogen atoms, alkyl groups or aryl groups.)

—Ar¹¹—Z—Ar¹²— (4)

(In the formula, Ar¹¹ and Ar¹² each independently represent a phenylene or naphthylene group, and Z represents O, CO or SO₂.)

The eleventh invention has the construction of the tenth invention, wherein either or both X and Y of the structural unit represented by formula (3) are NH.

The twelfth invention has the construction of any one of the first to eleventh inventions, wherein the first cushion material is a cushion material comprising a resin sheet sandwiched between a pair of second metal foils.

The thirteenth invention has the construction of the twelfth invention, wherein the second metal foil is a copper foil.

The fourteenth invention has the construction of the twelfth or thirteenth invention, wherein the second metal foil is provided with a matt surface, and is in contact with the resin sheet at the matt surface.

The fifteenth invention has the construction of any one of the twelfth to fourteenth inventions, wherein the resin sheet is a polytetrafluoroethylene sheet, aramid sheet, polyetherimide sheet, polyimide sheet or liquid crystal polymer sheet.

The sixteenth invention is a method for producing a metal foil laminate comprising metal foils on both sides of an insulating base material, the method comprising a second stack-preparing step in which a second stack is prepared having a laminar structure wherein a multilayer structure in which a plurality of first stacks, each comprising an insulating base material sandwiched between a pair of first metal foils, a pair of first spacers, a pair of second spacers and a pair of first cushion materials in that order, and layered via partition plates in the direction of lamination, are sandwiched between pairs of metal sheets and pairs of second cushion materials, in that order, and a second stack-hot pressing step in which the second stack is hot pressed with a pair of heating plates in the direction of lamination.

### Advantageous Effects of Invention

According to the invention, a first spacer, a second spacer and a first cushion material are inserted between each first metal foil and each metal sheet composing the metal foil laminate, and therefore it is possible to avoid transferring irregularities on the surface of each metal sheet to the surface of the metal foil laminate creating irregularities on the first metal foil, while it is also possible to avoid disturbing the pressure balance.

In addition, since second cushion materials are inserted between each of the heating plates and metal sheets, it is possible to avoid a condition where heat transmitted from the heating plates to the metal foil laminate is increased, causing overheating.

As a result it is possible, when producing a metal foil laminate, to obtain a metal foil laminate with a satisfactory outer appearance, while also improving the flatness of the metal foil laminate.

### BRIEF DESCRIPTION OF DRAWINGS

FIG. 1 is a perspective view of a metal foil laminate according to embodiment 1.

FIG. 2 is a cross-sectional view of a metal foil laminate according to embodiment 1.

FIG. 3 is a schematic cross-sectional view showing a method for producing a metal foil laminate according to embodiment 1.

FIG. 4 is a general schematic drawing of a hot press apparatus for embodiment 1.

FIG. 5 is a schematic cross-sectional view showing a method for producing a metal foil laminate according to embodiment 2.

### DESCRIPTION OF EMBODIMENTS

Embodiments of the invention will now be described.

### Embodiment 1

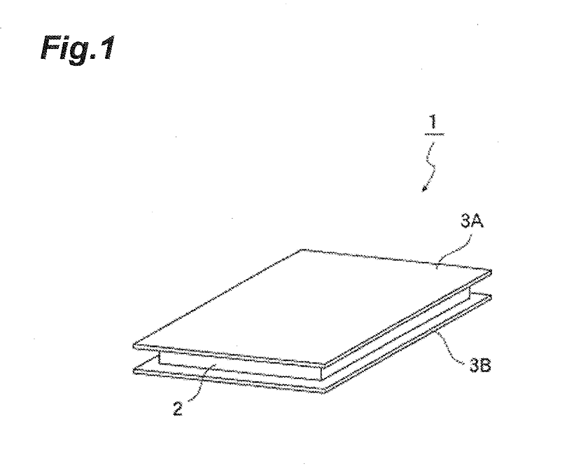

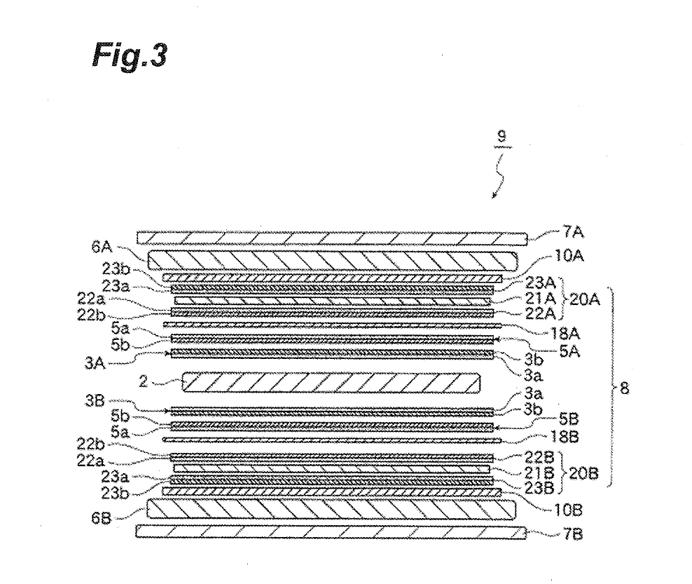

Embodiment 1 will now be explained with reference to FIGS. 1 to 4. Embodiment 1 will be explained as a case of producing a single-level structure, i.e. a single metal foil laminate with a single hot pressing. In FIG. 3, the different members are shown in a separated manner for ease of explanation.

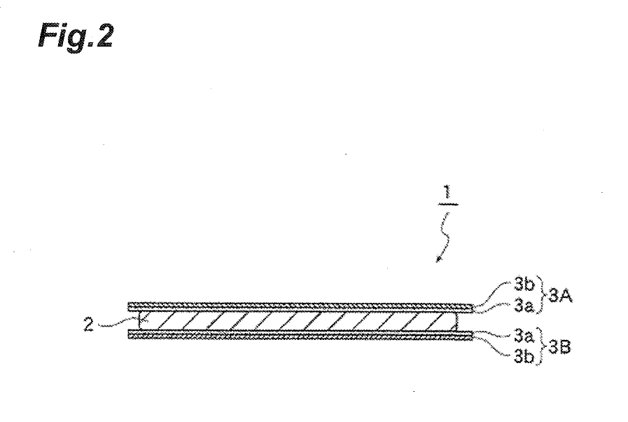

As shown in FIG. 1, the metal foil laminate 1 of embodiment 1 has a square tabular resin-impregnated base material 2 (insulating base material), with first metal foils 3 (3A, 3B) such as square sheet-shaped copper foils integrally bonded on the top and bottom sides of the resin-impregnated base material 2. As shown in FIG. 2, each first metal foil 3 has a two-layer structure comprising a matt surface 3a and a shine surface 3b, and contacts the resin-impregnated base material 2 on the matt surface 3a side. The size (sides of the square) of each first metal foil 3 is slightly larger than the size of the resin-impregnated base material 2. In order to obtain a metal foil laminate 1 with satisfactory surface smoothness, the thickness of each first metal foil 3 is preferably between 18 μm and 100 μm, from the viewpoint of ready availability and ease of handling.

The resin-impregnated base material 2 is a prepreg in which a liquid crystal polyester with excellent heat resistance and electrical characteristics is impregnated in inorganic fibers (preferably a glass cloth) or carbon fibers. A liquid crystal polyester is a polyester having the property of exhibiting optical anisotropy when melted, and forming an anisotropic melt at a temperature of 450° C. or below. The liquid crystal polyester used for this embodiment comprises a structural unit represented by formula (1) (hereunder referred to as “formula (1) structural unit”), a structural unit represented by formula (2) (hereunder referred to as “formula (2) structural unit”) and a structural unit represented by formula (3) (hereunder referred to as “formula (3) structural unit”), the content of the formula (1) structural unit being 30-45 mol %, the content of the formula (2) structural unit being 27.5-35 mol % and the content of the formula (3) structural unit being 27.5-35 mol %, with respect to the total content of all of the structural units (units: mol, obtained by dividing the weight of each structural unit composing the liquid crystal polyester by the formula weight of each structural unit to determine the content of each structural unit in terms of mass-equivalents (moles), and totaling them).

—O—Ar¹—CO— (1)

—CO—Ar²—CO— (2)

—X—Ar³—Y— (3)

(In the formulas, Ar¹ represents a phenylene or naphthylene group, Ar² represents a phenylene or naphthylene group or a group represented by formula (4), Ar³ represents a phenylene group or a group represented by formula (4), and X and Y each independently represent O or NH. The hydrogens of the groups represented by Ar¹, Ar² and Ar³ may each independently be replaced by halogen atoms, alkyl groups or aryl groups.)

—Ar¹¹—Z—Ar¹²— (4)

(In the formula, Ar¹¹ and Ar¹² each independently represent a phenylene or naphthylene group, and Z represents O, CO or SO₂.)

The formula (1) structural unit is a structural unit derived from an aromatic hydroxycarboxylic acid. Examples of aromatic hydroxycarboxylic acids include parahydroxybenzoic acid, metahydroxybenzoic acid, 2-hydroxy-6-naphthoic acid, 2-hydroxy-3-naphthoic acid and 1-hydroxy-4-naphthoic acid. The formula (1) structural unit may also include different types of structural units. In this case, the total will constitute the proportion of the formula (1) structural unit.

The formula (2) structural unit is a structural unit derived from an aromatic dicarboxylic acid. Examples of aromatic dicarboxylic acids include terephthalic acid, isophthalic acid, 2,6-naphthalenedicarboxylic acid, 1,5-naphthalenedicarboxylic acid, diphenyl ether-4,4′-dicarboxylic acid, diphenylsulfone-4,4′-dicarboxylic acid and diphenyl ketone-4,4′-dicarboxylic acid. The formula (2) structural unit may also include different types of structural units. In this case, the total will constitute the proportion of the formula (2) structural unit.

The formula (3) structural unit is a structural unit derived from an aromatic diol, or an aromatic amine or aromatic diamine with a phenolic hydroxyl group (phenolic hydroxyl). Examples of aromatic diols include hydroquinone, resorcin, 2,2-bis(4-hydroxy-3,5-dimethylphenyl)propane, bis(4-hydroxyphenyl)ether, bis-(4-hydroxyphenyl)ketone and bis-(4-hydroxyphenyl)sulfone. The formula (3) structural unit may also include different types of structural units. In this case, the total will constitute the proportion of the formula (3) structural unit.

Aromatic amines with phenolic hydroxyl groups include 4-aminophenol (p-aminophenol) and 3-aminophenol (m-aminophenol). Their aromatic diamines include 1,4-phenylenediamine and 1,3-phenylenediamine.

The liquid crystal polyester used for this embodiment preferably has solvent solubility. Solvent solubility means solubility in a solvent to a concentration of at least 1 wt % at a temperature of 50° C. The solvent is one of the solvents suitable for use in preparation of the liquid composition described hereunder, and it will be described in detail below.

A liquid crystal polyester having such solvent solubility preferably comprises, as the formula (3) structural unit, a structural unit derived from an aromatic amine with a phenolic hydroxyl group, and/or a structural unit derived from an aromatic diamine. That is, the formula (3) structural unit preferably comprises a structural unit wherein at least one of X and Y is an NH group (a structural unit of formula (3′), hereunder referred to as “formula (3′) structural unit”), since this will tend to produce excellent solvent solubility for the suitable solvents mentioned below (aprotic polar solvents). Most preferably, all of the formula (3) structural unit essentially consists of the formula (3′) structural unit. The formula (3′) structural unit is advantageous as it will result in sufficient solvent solubility of the liquid crystal polyester, while also increasing the low water absorbing property of the liquid crystal polyester.

—X—Ar³—NH— (3′)

(In the formula, Ar³ and X have the same definitions as in formula (3).)

The formula (3) structural unit is more preferably present in the range of 30-32.5 mol % with respect to the total content of all of the structural units. This will result in even more satisfactory solvent solubility. A liquid crystal polyester thus having the formula (3′) structural unit as the formula (3) structural unit is also advantageous not only in terms of solubility in solvents and low water absorbing property, but also in terms of further facilitating production of the resin-impregnated base material 2 using the liquid composition described hereunder.

The formula (1) structural unit is preferably present in the range of 30-45 mol % and more preferably in the range of 35-40 mol %, with respect to the total content of all of the structural units. A liquid crystal polyester comprising the formula. (1) structural unit in that molar fraction will tend to have more excellent solubility in solvents, while sufficiently maintaining liquid crystallinity. Also, in consideration of the availability of aromatic hydroxycarboxylic acids that yield formula (1) structural units, the aromatic hydroxycarboxylic acid is preferably p-hydroxybenzoic acid and/or 2-hydroxy-6-naphthoic acid.

The formula (2) structural unit is preferably present in the range of 27.5-35 mol % and more preferably in the range of 30-32.5 mol %, with respect to the total content of all of the structural units. A liquid crystal polyester comprising the formula (2) structural unit in that molar fraction will tend to have more excellent solubility in solvents, while sufficiently maintaining liquid crystallinity. Also, in consideration of the availability of aromatic dicarboxylic acids that yield formula (2) structural units, the aromatic dicarboxylic acid is preferably one or more selected from the group consisting of terephthalic acid, isophthalic acid and 2,6-naphthalenedicarboxylic acid.

In addition, in order for the obtained liquid crystal polyester to exhibit higher liquid crystallinity, the molar fraction of the formula (2) structural unit and the formula (3) structural unit is preferably in the range of 0.9/1-1/0.9, as [formula (2) structural unit]/[formula (3) structural unit].

A method for producing a liquid crystal polyester will now be explained in brief.

The liquid crystal polyester can be produced by any of various known methods. For production of a suitable liquid crystal polyester, i.e. a liquid crystal polyester comprising the formula (1) structural unit, the formula (2) structural unit and the formula (3) structural unit, a preferred method for convenience of operation is one in which monomers yielding these structural units are converted to ester-forming and amide-forming derivatives, and then polymerized to produce a liquid crystal polyester.

These ester-forming and amide-forming derivatives will now be explained with examples.

Ester-forming and amide-forming derivatives of monomers with carboxyl groups, such as aromatic hydroxycarboxylic acids and aromatic dicarboxylic acids, include the following. Specifically, these include derivatives wherein the carboxyl groups are highly-reactive groups such as acid chlorides and acid anhydrides, so as to promote reaction for production of a polyester or polyamide, or derivatives wherein the carboxyl groups are groups that form esters with alcohols or ethylene glycol, so as to produce a polyester or polyamide by transesterification or transamidation reaction.

An ester-forming or amide-forming derivative of a monomer with a phenolic hydroxyl group, such as an aromatic hydroxycarboxylic acid or aromatic diol, may be one wherein the phenolic hydroxyl group forms an ester with a carboxylic acid, so as to produce a polyester or polyamide by transesterification reaction.

Examples of amide-forming derivatives of monomers with amino groups, such as aromatic diamines, include those wherein the amino groups form amides with carboxylic acids, so as to produce polyamides by transamidation reaction.

The following method is a preferred one, for more convenient production of a liquid crystal polyester. First, an aromatic hydroxycarboxylic acid, and a monomer having a phenolic hydroxyl group and/or an amino group, such as an aromatic diol, phenolic hydroxyl group-containing aromatic amine or aromatic diamine, are acylated with a fatty acid anhydride to produce an ester-forming or amide-forming derivative (acylated product). Next, polymerization is carried out so that the acyl group of the acylated product and the carboxyl group of the monomer with a carboxyl group produce transesterification or transamidation, as a particularly preferred method of producing a liquid crystal polyester.

Such a method for producing a liquid crystal polyester is disclosed in Japanese Unexamined Patent Application Publication No. 2002-220444 or Japanese Unexamined Patent Application Publication No. 2002-146003, for example.

For the acylation, the amount of fatty acid anhydride added is preferably 1-1.2 equivalents and more preferably 1.05-1.1 equivalents with respect to the total of the phenolic hydroxyl groups and amino groups. If the amount of fatty acid anhydride added is less than 1 equivalent, the acylated product or starting monomer will undergo sublimation during polymerization, tending to obstruct the reaction system. If it is greater than 1.2 equivalents, coloration will tend to become notable in the obtained liquid crystal polyester.

The acylation is preferably accomplished by reaction at 130-180° C. for 5-10 minutes, and more preferably by reaction at 140-160° C. for 10 minutes to 3 hours.

The fatty acid anhydride used for the acylation is preferably acetic anhydride, propionic anhydride, butyric anhydride or isobutyric anhydride, or a mixture of two or more of these, from the viewpoint of cost and manageability. Acetic anhydride is most preferred.

The polymerization following acylation is preferably carried out at 130-400° C. while raising the temperature at a rate of 0.1-50° C./min, and more preferably it is carried out at 150-350° C. while raising the temperature at a rate of 0.3-5° C./min.

For the polymerization, the acyl group of the acylated product is preferably used at 0.8-1.2 equivalents with respect to the carboxyl group.

During the acylation and/or polymerization, the equilibrium shifts based on Le Chatelier-Braun's law (principle of mobile equilibrium), and therefore the fatty acid by-product and unreacted fatty acid anhydride are preferably evaporated and distilled out of the system.

The acylation and polymerization may also be conducted in the presence of a catalyst. The catalyst used may be one that is known in the prior art as a polymerization catalyst for polyesters, and examples include metal salt catalysts such as magnesium acetate, stannous acetate, tetrabutyl titanate, lead acetate, sodium acetate, potassium acetate and antimony trioxide, and organic compound catalysts such as N,N-dimethylaminopyridine and N-methylimidazole.

Of these catalysts, there are preferably used heterocyclic compounds containing 2 or more nitrogen atoms, such as N,N-dimethylaminopyridine and N-methylimidazole (see Japanese Unexamined Patent Application Publication No. 2002-146003).

The catalyst is usually introduced together during introduction of the monomers, and it does not necessarily need to be removed after acylation. When the catalyst is not removed, it may be directly transferred to the polymerization after acylation.

The liquid crystal polyester obtained by the polymerization may be used directly for this embodiment, but for more improved properties such as heat resistance and liquid crystallinity, it is preferably subjected to further high molecularization. Solid-phase polymerization is preferably carried out for such high molecularization. A series of steps for solid-phase polymerization will now be described. The relatively low-molecular-weight liquid crystal polyester obtained by the polymerization is removed out and pulverized into a powder or flaky form. Next, for example, the pulverized liquid crystal polyester is subjected to heat treatment at 20-350° C. for 1-30 hours in a solid phase, under an atmosphere of an inert gas such as nitrogen. Solid-phase polymerization can be accomplished by such a procedure. The solid-phase polymerization may be conducted while stirring, or while standing without stirring. The preferred conditions for solid-phase polymerization, from the viewpoint of obtaining a liquid crystal polyester having a suitable flow start temperature, as explained below, may be more specifically stipulated as a reaction temperature exceeding 210° C., and more preferably in the range of 220-350° C. The reaction time is preferably selected between 1 and 10 hours.

The liquid crystal polyester used for this embodiment preferably has a flow start temperature of 250° C. or higher, from the viewpoint of obtaining even higher adhesiveness between the conductive layer and insulating layer (resin-impregnated base material 2) to be formed on the resin-impregnated base material 2. The flow start temperature referred to here is the temperature at which the melt viscosity of the liquid crystal polyester is no greater than 4800 Pa·s under a pressure of 9.8 MPa, when the melt viscosity is evaluated using a flow tester. The flow start temperature is known to those skilled in the art as a measure of the molecular weight for liquid crystal polyesters (see “Ekishou Polymer-Gousei/Seikei/Ouyou”, Koide, N., p. 95-105, CMC, Jun. 5, 1987).

The flow start temperature of the liquid crystal polyester is more preferably between 250° C. and 300° C. If the flow start temperature is no higher than 300° C., the solubility of the liquid crystal polyester in solvents will be more satisfactory, and when a liquid composition has been obtained as described below, the viscosity will not be notably increased, and therefore the manageability of the liquid composition will tend to be satisfactory. From this viewpoint, a liquid crystal polyester with a flow start temperature of between 260° C. and 290° C. is more preferred. The polymerization conditions for the solid-phase polymerization mentioned above may be appropriately optimized to control the flow start temperature of the liquid crystal polyester to within this preferred range.

The resin-impregnated base material 2 is most preferably one obtained by impregnating a liquid composition comprising a liquid crystal polyester and a solvent (especially a liquid composition with the liquid crystal polyester dissolved in a solvent) into inorganic fibers (preferably a glass cloth) or carbon fibers, and then removing the solvent by drying. The coverage of the liquid crystal polyester on the resin-impregnated base material 2 after removal of the solvent is preferably 30-80 wt % and more preferably 40-70 wt %, based on the mass of the obtained resin-impregnated base material 2.

When using the aforementioned preferred liquid crystal polyester, and especially the liquid crystal polyester comprising the formula (3′) structural unit mentioned above, as the liquid crystal polyester for this embodiment, the liquid crystal polyester exhibits sufficient solubility in aprotic solvents that do not contain halogen atoms.

Aprotic solvents containing no halogen atoms include, for example, ether-based solvents such as diethyl ether, tetrahydrofuran and 1,4-dioxane; ketone-based solvents such as acetone and cyclohexanone; ester-based solvents such as ethyl acetate; lactone-based solvents such as γ-butyrolactone; carbonate-based solvents such as ethylene carbonate and propylene carbonate; amine-based solvents such as triethylamine and pyridine; nitrile-based solvents such as acetonitrile and succinonitrile; amide-based solvents such as N,N-dimethylformamide, N,N-dimethylacetamide, tetramethylurea and N-methylpyrrolidone; nitro-based solvents such as nitromethane and nitrobenzene; sulfur-based solvents such as dimethyl sulfoxide and sulfolane; and phosphorus-based solvents such as hexamethylphosphoric acid amide and tri-n-butylphosphoric acid. The solvent solubility of the liquid crystal polyester is the solubility in at least one aprotic solvent selected from among those mentioned above.

From the viewpoint of further improving the solvent solubility of the liquid crystal polyester and easily obtaining a liquid composition, it is preferred to use an aprotic polar solvent with a dipole moment of 3-5, among the solvents mentioned above. More specifically, there are preferred amide-based solvents and lactone-based solvents, with N,N-dimethylformamide (DMF), N,N-dimethylacetamide (DMAc) and N-methylpyrrolidone (NMP) being more preferred for use. If the solvent is a highly volatile solvent with a boiling point of no higher than 180° C. at 1 atmosphere, it will be more easily removed after impregnating the liquid composition into the sheet (inorganic fibers or carbon fibers). From this viewpoint, DMF or DMAc is particularly preferred. The use of such amide-based solvents is advantageous in that variation in thickness does not readily occur during production of the resin-impregnated base material 2, and therefore a conductive layer is more easily formed on the resin-impregnated base material 2.

When such an aprotic solvent is used in the liquid composition, the liquid crystal polyester is preferably dissolved at 20-50 parts by weight and more preferably 22-40 parts by weight with respect to 100 parts by weight of the aprotic solvent. If the content of the liquid crystal polyester in the liquid composition is within this range, the efficiency of impregnation of the liquid composition in the sheet during production of the resin-impregnated base material 2 will be satisfactory, and this will tend to avoid the inconvenience of thickness variation during removal of the solvent by drying after impregnation.

There may also be added to the liquid composition one or more resins other than the liquid crystal polyester, including thermoplastic resins such as polypropylene, polyamides, polyesters, polyphenylene sulfide, polyetherketones, polycarbonates, polyethersulfones and polyphenyl ethers as well as their modified forms, and polyetherimides; elastomers such as copolymers of glycidyl methacrylate and polyethylene; and thermosetting resins such as phenol resins, epoxy resins, polyimide resins and cyanate resins, in ranges that do not interfere with the object of the invention. However, when such other resins are used, they are also preferably soluble in the solvent used in the liquid composition.

There may also be useful added to the liquid composition one or more of various additives, including inorganic fillers such as silica, alumina, titanium oxide, barium titanate, strontium titanate, aluminum hydroxide and calcium carbonate; organic fillers such as cured epoxy resins, crosslinked benzoguanamine resins and crosslinked acrylic polymers; silane coupling agents, antioxidants, ultraviolet absorbers and the like, in ranges that do not impair the effect of the invention, for the purpose of improving the dimensional stability, thermal conductivity and electrical characteristics.

If necessary, the liquid composition may be subjected to filtration treatment using a filter or the like, to remove fine contaminants present in the solution.

The liquid composition may additionally be subjected to degassing if necessary.

The base material to be impregnated with the liquid crystal polyester used for this embodiment comprises inorganic fibers and/or carbon fibers. The inorganic fibers are ceramic fibers such as glass, and may be glass fibers, alumina-based fibers, silicon-containing ceramic-based fibers, or the like. Preferred among these are sheets made primarily of glass fibers, i.e. glass cloths, because of their high mechanical strength and good availability.

A glass cloth is preferably one composed of alkali-containing glass fibers, non-alkaline glass fibers or low dielectric glass fibers. The fibers composing the glass cloth may partially include ceramic fibers comprising a ceramic other than glass, or carbon fibers. The fibers composing the glass cloth may be surface-treated with a coupling agent such as an aminosilane-based coupling agent, epoxysilane-based coupling agent or titanate-based coupling agent.

The method of producing a glass cloth comprising such fibers may be a method in which the fibers that are to form the glass cloth are dispersed in water, a sizing agent such as an acrylic resin is added as necessary, and a sheet is formed using a paper machine and then dried to obtain a nonwoven fabric, or a method using a known weaving machine.

The method used for weaving fibers may be plain weaving, satin weaving, twill weaving, mat weaving, or the like. The weaving density may be 10-100 yarns/25 mm, and the weight per unit area of the glass cloth is preferably 10-300 g/m². The thickness of the glass cloth will usually be about 10-200 μm, with 10-180 μm being more preferred.

Glass cloths, readily available on the market, may also be used. Various types of such glass cloths are commercially available as insulator-impregnated base materials for electronic components, and are available from Asahi Shwebel, Nitto Boseki Co., Ltd., Arisawa Manufacturing Co., Ltd., and elsewhere. The preferred thicknesses for commercially available glass cloths are 1035, 1078, 2116 and 7628, by the IPC designation.

Impregnation of a liquid composition into a glass cloth that is preferred as the inorganic fiber can typically be accomplished by preparing a dipping tank containing the liquid composition, and dipping the glass cloth into the dipping tank. The liquid crystal polyester content of the liquid composition used, the dipping time in the dipping tank and the rate at which the liquid composition-impregnated glass cloth is raised may be appropriately optimized for easy control to the preferred liquid crystal polyester coverage specified above.

Thus, the resin-impregnated base material 2 can be produced by removing the solvent from the glass cloth that has been impregnated with the liquid composition. There are no particular restrictions on the method of removing the solvent, but evaporation of the solvent is preferred from the viewpoint of procedural convenience, and a method of heating, pressure reduction, ventilation or a combination of these may be employed. Also, for production of the resin-impregnated base material 2, removal of the solvent may be further followed by heat treatment. Such heat treatment can induce further high molecularization of the liquid crystal polyester in the resin-impregnated base material 2 after removal of the solvent. The conditions for the heat treatment may be, for example, a method of heat treatment at 240-330° C. for 1-30 hours, under an atmosphere of an inert gas such as nitrogen. From the viewpoint of obtaining a metal foil laminate with more satisfactory heat resistance, the heat treatment conditions are preferably such that the heating temperature is higher than 250° C. Even more preferably, the heating temperature is in the range of 260-320° C. The heat treatment time is preferably selected between 1 and hours from the viewpoint of productivity.

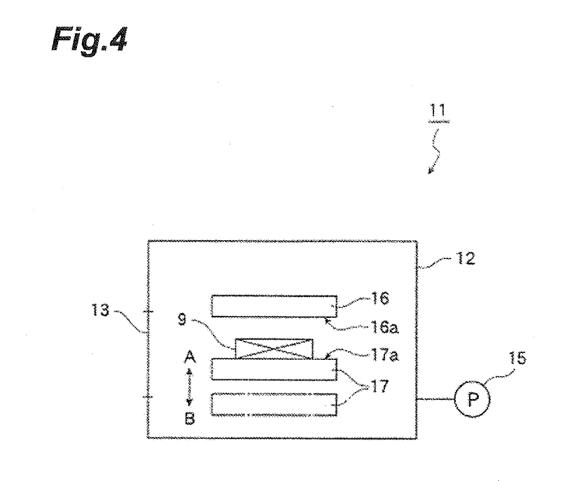

The hot press apparatus 11 used for production of the metal foil laminate 1 described above has a cuboid chamber 12, as shown in FIG. 4, with a door 13 mounted in a freely opening and closing manner on a side of the chamber 12 (the left side in FIG. 4). Also, a vacuum pump is connected to the chamber 12, so as to allow pressure reduction of the interior of the chamber 12 to the prescribed pressure (preferably a pressure of no greater than 2 kPa). In the chamber 12 there is also set a pair of upper and lower heating plates (an upper heating plate 16 and a lower heating plate 17), in a mutually opposing configuration. The upper heating plate 16 is vertically fixed with respect to the chamber 12, while the lower heating plate 17 is provided to be freely movable in the vertical directions of arrows A and B with respect to the upper heating plate 16. A pressing side 16a is formed on the bottom side of the upper heating plate 16, and a pressing side 17a is formed on the top side of the lower heating plate 17.

Production of a metal foil laminate 1 employing this hot press apparatus 11 can be accomplished by the following procedure.

First, as shown in FIG. 3, a second stack 9 is formed having a laminar structure wherein a first stack 8, comprising a resin-impregnated base material 2 sandwiched between a pair of first metal foils 3A, 3B, a pair of first spacers 5A, 5B, a pair of second spacers 18A, 18B and a pair of first cushion materials 20A, 20B in that order, is sandwiched between a pair of partition plates 10A, 10B, a pair of metal sheets 6A, 6B and a pair of second cushion materials 7A, 7B in that order. Formation of the second stack 9 can be accomplish by stacking each of the members for the second stack 9 in order from the bottom. A partition plate 10 does not necessarily need to be used for production of the second stack 9.

Formation of the second stack 9 may be accomplished by sandwiching the resin-impregnated base material 2 between the pair of first metal foils 3A, 3B, the pair of first spacers 5A, 5B, the pair of second spacers 18A, 18B and the pair of first cushion materials 20A, 20B in that order to obtain the first stack 8, and then sandwiching the first stack 8 between the pair of partition plates 10A, 10B, the pair of metal sheets 6A, 6B and the pair of second cushion materials 7A, 7B, in that order.

Each first metal foil 3 will typically be a copper foil, and as mentioned above, it has a two-layer structure comprising a matt surface 3a and a shine surface 3b. Each first metal foil 3 has the matt surface 3a facing the inner side (the resin-impregnated base material 2 side). Also, each first spacer 5 will typically be a copper foil or SUS foil, and it has a two-layer structure comprising a matt surface 5a and a shine surface 5b. Each first spacer 5 has the shine surface 5b facing the inner side (the first metal foil 3 side). Each second spacer 18 will also typically be an SUS foil or copper foil.

Each first cushion material 20 may be a cushion material comprising a resin sheet such as a polytetrafluoroethylene sheet 21 sandwiched between a pair of second metal foils 22, 23. Copper foils may be used as the second metal foils 22, 23. Preferably, the second metal foil 22 has a two-layer structure comprising a matt surface 22a and a shine surface 22b, and the second metal foil 23 has a two-layer structure comprising a matt surface 23a and a shine surface 23b. In this case, the second metal foils 22, 23 have their respective matt surfaces 22a, 23a facing the inner side (the polytetrafluoroethylene sheet 21 side).

An SUS sheet may be used for each partition plate 10. SUS sheets may also be used for each metal sheet 6, and an aramid cushion or carbon cushion may be used for each second cushion material 7. When an aramid cushion is used as the second cushion material 7, the excellent handleability of the aramid cushion allows formation of the second stack 9 to be accomplished easily and rapidly.

When the second stack 9 has been obtained in this manner, it is transferred to the second stack-hot pressing step, and the second stack 9 is hot pressed by the upper heating plate 16 and lower heating plate 17 in the direction of lamination (the vertical direction in FIG. 3).

Specifically, as shown in FIG. 4, first the door 13 is opened, and the second stack 9 is set on the pressing side 17a of the lower heating plate 17. The door 13 is then closed, and the vacuum pump 15 is activated to reduce the pressure in the chamber 12 to the prescribed pressure. In this state, the lower heating plate 17 is appropriately raised in the direction of arrow A to lightly anchor the second stack 9 between the upper heating plate 16 and the lower heating plate 17. The upper heating plate 16 and lower heating plate 17 are then heated. Upon reaching increase to the prescribed temperature, the lower heating plate 17 is further raised in the direction of arrow A to press the second stack 9 between the upper heating plate 16 and lower heating plate 17. This forms a metal foil laminate 1 between the upper heating plate 16 and lower heating plate 17.

During this time, the matt surface 3a of each first metal foil 3 of the first stack 8 is in contact with the resin-impregnated base material 2, and therefore the pair of first metal foils 3A, 3B are firmly fixed to the resin-impregnated base material 2 by an anchor effect.

In the second stack 9, each first spacer 5, each second spacer 18 and each first cushion material 20 is situated between each first metal foil 3 composing the metal foil laminate 1 and each metal sheet 6. Thus, even if irregularities are produced on the surface with repeated use of the metal sheet 6, there is no risk of the irregularities being transferred to the surface of the metal foil laminate 1 and producing irregularities in the first metal foil 3. Moreover, even if each of the members composing the second stack 9 are hot pressed while stacked as several layers, a condition of disturbed pressure balance is not created. Thus, it is possible to avoid a condition in which the outer appearance of the metal foil laminate 1 is impaired by irregularities on the surface of the metal sheet 6. Furthermore, since the shine surface 3b of each first metal foil 3 and the shine surface 5b of each first spacer 5 are in contact, it is possible to avoid the inconvenience of fine irregularities of the matt surface 5a of each first spacer 5 being transferred to each first metal foil 3.

In addition, since the second cushion material 7A with excellent heat resistance is situated between the upper heating plate 16 and the metal sheet 6A while the second cushion material 7B with excellent heat resistance is situated between the lower heating plate 17 and the metal sheet 6B, there is no risk of an increased amount of heat being transmitted from the upper heating plate 16 or lower heating plate 17 to the metal foil laminate 1, thereby causing overheating. Thus, even when a copper foil is employed as the first metal foil 3, it is possible to avoid a condition wherein the copper foil is discolored by oxidation, thereby impairing the outer appearance of the metal foil laminate 1.

Furthermore, since the respective polytetrafluoroethylene sheet 21 in each first cushion material 20 is sandwiched by the pair of second metal foils 22, 23, and both of the second metal foils 22, 23 have their shine surfaces 22b, 23b facing outside (the second spacer 18 side and partition plate 10 side), it is possible to avoid the problem of the first cushion material 20 adhering to the second spacer 18 or partition plate during hot pressing of the second stack 9.

In addition, since formation of the metal foil laminate 1 is carried out under reduced pressure, even if a copper foil is employed as the first metal foil 3 or first spacer 5, it is possible to prevent from the start a condition where the copper foil may become oxidized, unlike cases where it is carried out under an oxygen atmosphere.

In addition, since the metal sheet 6 has excellent thermal conductivity and durability, it can be used for prolonged periods.

The conditions for the hot pressing treatment in the second stack-hot pressing step are preferably optimized to appropriate treatment temperature and treatment pressure, so that the obtained laminated body exhibits satisfactory surface smoothness. The treatment temperature may be based on the temperature conditions for the heat treatment employed for production of the resin-impregnated base material 2 used in hot pressing. Specifically, if Tmax[° C.] is the maximum temperature of the temperature conditions for heat treatment used for production of the resin-impregnated base material 2, hot pressing is preferably conducted at a temperature exceeding Tmax, and more preferably hot pressing is conducted at a temperature of at least Tmax+5[° C.]. The upper limit for the temperature in hot pressing is selected to be below the decomposition temperature of the liquid crystal polyester in the resin-impregnated base material 2 that is used, but it is preferably at least 30° C. below the decomposition temperature. The decomposition temperature referred to here is determined by known means such as thermogravimetric analysis. Also, preferably the treatment time for hot pressing is selected between 10 minutes and 5 hours, and the pressing pressure is selected between 1-30 MPa.

Once the prescribed time has elapsed under this pressed state, the upper heating plate 16 and lower heating plate 17 are heated while maintaining the pressed state of the second stack 9. Next, the temperature is lowered to the prescribed temperature, and the lower heating plate 17 is appropriately lowered in the direction of arrow B so that the second stack 9 is lightly sandwiched between the upper heating plate 16 and the lower heating plate 17. The state of pressure reduction in the chamber 12 is then released, and the lower heating plate 17 is further lowered in the direction of arrow B, to separate the second stack 9 from the pressing side 16a of the upper heating plate 16. Finally, the door 13 is opened and the second stack 9 is removed from the chamber 12.

Once the second stack 9 has been removed, a step is carried out in which the rest of the structure other than the metal foil laminate 1, i.e. the first spacers 5A, 5B, the second spacers 18A, 18B, the first cushion materials 20A, 20B, the partition plates 10A, 10B, the metal sheets 6A, 6B and the second cushion materials 7A, 7B, are removed from the second stack 9, and the metal foil laminate 1 is separated. Since the shine surface 3b of each first metal foil 3 and the shine surface 5b of each first spacer 5 are in contact during this time, it is possible to easily separate each first spacer 5 from each first metal foil 3.

The production steps for the metal foil laminate 1 are thus completed, to obtain the metal foil laminate 1.

### Embodiment 2

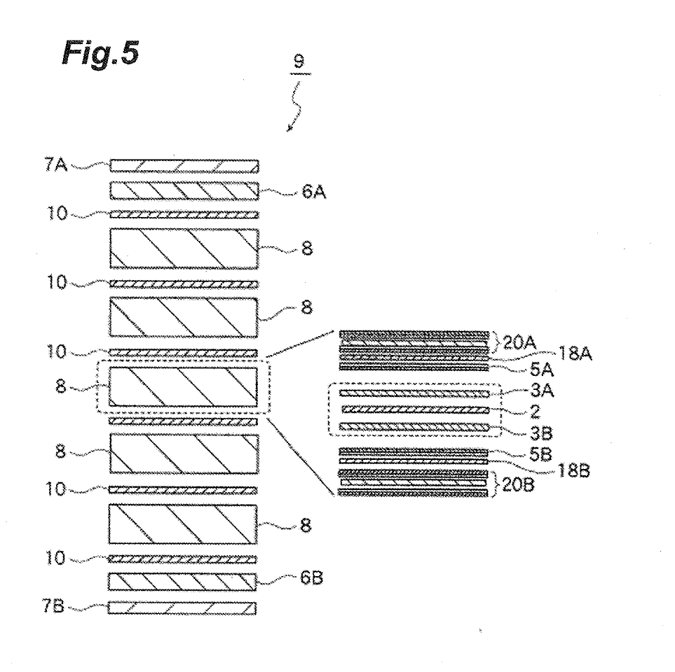

Embodiment 2 will now be explained with reference to FIG. 5. Embodiment 2 will be explained as a case of producing a 5-level structure, i.e. 5 metal foil laminates with a single hot pressing. In FIG. 5, the different members are shown in a separated manner for ease of explanation.

The metal foil laminate 1 and hot press apparatus 11 for embodiment 2 have the same construction as for embodiment 1.

When this hot press apparatus 11 is used to produce a metal foil laminate 1, the five metal foil laminates 1 are simultaneously produced as described below, according to the production steps for the metal foil laminate 1 of embodiment 1 explained above.

First, as shown in FIG. 5, a second stack 9 is prepared having a laminar structure wherein both outer sides of a multilayer structure comprising five first stacks 8, each comprising a resin-impregnated base material 2 sandwiched between a pair of first metal foils 3A, 3B, a pair of first spacers 5A, 5B, a pair of second spacers 18A, 18B and a pair of first cushion materials 20A, 20B in that order, via partition plates 10 in the direction of lamination (the vertical direction in FIG. 5), are sandwiched between a pair of metal sheets 6A, 6B and a pair of second cushion materials 7A, 7B in that order. In FIG. 5, the structures of the first stacks 8 are omitted for easier understanding, but the structures of the first stacks 8 are the same as for embodiment 1.

The second stack 9 can be produced, for example, by placing a metal sheet 6B on a second cushion material 7B, subsequently stacking thereover a partition plate 10 and the members that are to compose the first stack 8 in that order from the bottom, repeating this stacking four times, and finally placing a partition plate 10, a metal sheet 6A and a second cushion material 7A thereover in that order. Alternatively, it can be produced by preparing five first stacks 8, each having a resin-impregnated base material 2 sandwiched between a pair of first metal foils 3A, 3B, a pair of first spacers 5A, 5B, a pair of second spacers 18A, 18B and a pair of first cushion materials 20A, 20B in that order, and then stacking the five first stacks 8 via partition plates 10 in the direction of lamination, and sandwiching them between a pair of metal sheets 6A, 6B and a pair of second cushion materials 7A, 7B, in that order, from both outer sides.

When the second stack 9 has thus been obtained, it is transferred to a second stack-hot pressing step, and the second stack 9 is hot pressed with an upper heating plate 16 and lower heating plate 17 in the direction of lamination (the vertical direction in the FIG. 5), in the same manner as embodiment 1 described above. This simultaneously forms five metal foil laminates 1 between the upper heating plate 16 and lower heating plate 17.

During this time, the matt surface 3a of each first metal foil 3 of each first stack 8 is in contact with the resin-impregnated base material 2, and therefore the pair of first metal foils 3A, 3B are firmly fixed to the resin-impregnated base material 2 by an anchor effect.

In the second stack 9, each first spacer 5, each second spacer 18 and each first cushion material 20 is situated between each first metal foil 3 composing each metal foil laminate 1 and each metal sheet 6 or each partition plate 10. Thus, even if irregularities are produced on the surface with repeated use of the metal sheets 6 or partition plates 10, there is no risk of the irregularities being transferred to the surface of the metal foil laminate 1 and producing irregularities in the first metal foil 3. Moreover, even if each of the members composing the second stack 9 are hot pressed while stacked as several layers, a condition of disturbed pressure balance is not created. Thus, it is possible to avoid a condition in which the outer appearance of the metal foil laminate 1 is impaired by irregularities on the surface of the metal sheets 6 or partition plates 10. Furthermore, since the shine surface 3b of each first metal foil 3 and the shine surface 5b of each first spacer 5 are in contact, it is possible to avoid the inconvenience of fine irregularities of the matt surface 5a of each first spacer 5 being transferred to each first metal foil 3.

In addition, since the second cushion material 7A with excellent heat resistance is situated between the upper heating plate 16 and the metal sheet 6A while the second cushion material 7B with excellent heat resistance is situated between the lower heating plate 17 and the metal sheet 6B, there is no risk of an increased amount of heat being transmitted from the upper heating plate 16 or lower heating plate 17 to the metal foil laminate 1, thereby causing overheating. Thus, even when a copper foil is employed as the first metal foil 3, it is possible to avoid a condition wherein the copper foil is discolored by oxidation, thereby impairing the outer appearance of the metal foil laminate 1.

Furthermore, since the respective polytetrafluoroethylene sheet 21 in each first cushion material 20 is sandwiched by the pair of second metal foils 22, 23, and both of the second metal foils 22, 23 have their shine surfaces 22b, 23b facing outside (the second spacer 18 side and partition plate 10 side), it is possible to avoid the problem of the first cushion material 20 adhering to the second spacer 18 or partition plate during hot pressing of the second stack 9.

In addition, since formation of the five metal foil laminates 1 is carried out under reduced pressure, even if a copper foil is employed as the first metal foil 3 or first spacer 5, it is possible to prevent from the start a condition where the copper foil may become oxidized., unlike cases where it is carried out under an oxygen atmosphere.

In addition, since the metal sheet 6 has excellent thermal conductivity and durability, it can be used for prolonged periods.

Also, the second stack 9 is removed from the chamber 12 and the five metal foil laminates 1 are separated from the second stack 9, similar to embodiment 1 described above. For example, five metal foil laminates 1 can be obtained by a step of removing the second cushion materials 7A, 7B and the metal sheets 6A, 6B from the second stack 9, while removing the partition plates 10 and separating each of the first stacks 8, and further removing the first spacers 5A, 5B, second spacers 18A, 18B and first cushion materials 20A, 20B from each of the first stacks 8. Since the shine surface 3b of each first metal foil 3 and the shine surface 5b of each first spacer 5 are in contact during this time, it is possible to easily separate each first spacer 5 from each first metal foil 3.

The production steps for the metal foil laminate 1 are thus completed, to obtain the five metal foil laminates 1.

### Other Embodiments

Embodiments 1 and 2 described above were explained with the assumption that the resin-impregnated base materials 2 are to be used as insulating base materials, but they may also be used instead of or together with insulating base materials other than resin-impregnated base materials 2 (for example, resin films such as liquid crystal polyester films or polyimide films).

Embodiments 1 and 2 described above were also explained assuming the use of liquid crystal polyesters as resins to be impregnated into the inorganic fibers or carbon fibers in the resin-impregnated base materials 2, but they may also be used instead of or together with resins other than liquid crystal polyesters (for example, thermosetting resins such as polyimide or epoxy resins).

Moreover, embodiments 1 and 2 were explained assuming the use of a polytetrafluoroethylene sheet 21 as the resin sheet, but the resin sheet may be of any type so long as it is a resin sheet. For example, an aramid sheet, polyetherimide sheet, polyimide sheet or liquid crystal polymer sheet is preferred from the viewpoint of excellent heat resistance, similar to a polytetrafluoroethylene sheet 21.

In addition, embodiment 2 was described as a 5-level structure, but it may have any other number of levels for the structure (for example, a 2-level structure or a 3-level structure).

### EXAMPLES

Examples of the invention will now be described. However, the invention is not limited to these examples.

<Fabrication of Resin-Impregnated Base Material>

In a reactor equipped with a stirrer, torque motor, nitrogen gas inlet tube, thermometer and reflux condenser there were charged 1976 g (10.5 mol) of 2-hydroxy-6-naphthoic acid, 1474 g (9.75 mol) of 4-hydroxyacetoanilide, 1620 g (9.75 mol) of isophthalic acid and 2374 g (23.25 mol) of acetic anhydride. After fully substituting the reactor interior with nitrogen gas, the temperature was raised to 150° C. over a period of 15 minutes under a nitrogen gas stream, and the temperature (150° C.) was maintained for 3 hours of reflux.

Next, the temperature was raised to 300° C. over a period of 170 minutes while distilling off the acetic acid by-product and unreacted acetic anhydride run-off, and when an increase in torque was observed, which was considered to indicate completion of the reaction, the contents were removed. The contents were cooled to room temperature, and after pulverizing with a pulverizer, a relatively low-molecular-weight liquid crystal polyester powder was obtained. The flow start temperature of the powder obtained in this manner was measured with a flow tester (“Model CFT-500” by Shimadzu Corp.), and found to be 235° C. The liquid crystal polyester powder was subjected to solid-phase polymerization by heat treatment at 223° C. for 3 hours in a nitrogen atmosphere. The flow start temperature of the liquid crystal polyester after solid-phase polymerization was 270° C.

A 2200 g portion of the obtained liquid crystal polyester was added to 7800 g of N,N-dimethylacetamide (DMAc), and the mixture was heated at 100° C. for 2 hours to obtain a liquid composition. The solution viscosity of the liquid composition was 320 cP. The melt viscosity is the value measured at a temperature of 23° C. using a Brookfield viscometer (“Model TVL-20”, product of Toki Sangyo Co., Ltd., rotor No. 21 (rotational speed: 5 rpm)).

The liquid composition obtained in this manner was impregnated into a glass cloth (glass cloth by Arisawa Manufacturing Co., Ltd., thickness: 45 μm, IPC designation: 1078) to prepare a resin-impregnated base material, and the resin-impregnated base material was dried with a hot air dryer, after which it was subjected to heat treatment at 290° C. for 3 hours under a nitrogen atmosphere for high molecularization of the liquid crystal polyester in the resin-impregnated base material. A heat-treated resin-impregnated base material was obtained as a result.

### Example 1

The heat-treated resin-impregnated base material was used to prepare a second stack having the structure shown in FIG. 3. Specifically, a second stack was prepared by laminating an aramid cushion as a second cushion material (aramid cushion by Ichikawa Techno-Fabrics Co., Ltd., thickness: 3 mm), an SUS sheet as a metal sheet (SUS304 with 5 mm thickness), an SUS sheet as a partition plate (SUS301 with 1 mm thickness), a copper foil to compose a first cushion material (“3EC-VLP” by Mitsui Mining & Smelting Co., Ltd., thickness: 18 μm), a polytetrafluoroethylene sheet to compose the first cushion material, (thickness: 300 μm), a copper foil to compose the first cushion material (“3EC-VLP” by Mitsui Mining & Smelting Co., Ltd., thickness: 18 μm), an SUS foil as a second spacer (SUS foil by Nikkin Steel Co., Ltd., thickness: 100 μm), a copper foil as a first spacer (“3EC-VLP” by Mitsui Mining & Smelting Co., Ltd., thickness: 18 μm), a copper foil to compose a metal foil laminate (“3EC-VLP” by Mitsui Mining & Smelting Co., Ltd., thickness: 18 μm), a resin-impregnated base material to compose the metal foil laminate, a copper foil to compose the metal foil laminate (“3EC-VLP” by Mitsui Mining & Smelting Co., Ltd., thickness: 18 min), a copper foil as a first spacer (“3EC-VLP” by Mitsui Mining & Smelting Co., Ltd., thickness: 18 μm), an SUS foil as a second spacer (SUS foil by Nikkin Steel Co., Ltd., thickness: 100 μm), a copper foil to compose a first cushion material (“3EC-VLP” by Mitsui Mining & Smelting Co., Ltd., thickness: 18 μm), a polytetrafluoroethylene sheet to compose the first cushion material (thickness: 300 μm), a copper foil to compose the first cushion material (“3EC-VLP” by Mitsui Mining & Smelting Co., Ltd., thickness: 18 μm), an SUS sheet as a partition plate (SUS301 with 1 mm thickness), an SUS sheet as a metal sheet (SUS304 with 5 mm thickness), and an aramid cushion as a second cushion material (aramid cushion by Ichikawa Techno-Fabrics Co., Ltd., thickness: 3 mm), in that order from the bottom.

Also, a high-temperature vacuum pressing machine (“KVHC-PRESS” by Kitagawa Seiki Co., Ltd., 300 mm length, 300 mm width) was used for hot pressing and integration of the second stack for 40 minutes under conditions with a temperature of 340° C. and a pressure of MPa, under reduced pressure of 0.2 kPa, to obtain a metal foil laminate.

### Example 2

The heat-treated resin-impregnated base material was used to prepare a second stack having the structure shown in FIG. 3. Specifically, a second stack was prepared by laminating an aramid cushion as the second cushion material (aramid cushion by Ichikawa Techno-Fabrics Co., Ltd., thickness: 3 mm), an SUS sheet as a metal sheet (SUS304 with 5 mm thickness), an SUS sheet as a partition plate (SUS301 with 1 mm thickness), a copper foil to compose a first cushion material (“3EC-VLP” by Mitsui Mining & Smelting Co., Ltd., thickness: 18 μm), a polyimide sheet to compose the first cushion material (“KAPTONE® Film” by Toray-DuPont Co., Ltd., thickness: 300 μm), a copper foil to compose the first cushion material (“3EC-VLP” by Mitsui Mining & Smelting Co., Ltd., thickness: 18 μm), an SUS foil as a second spacer (SUS foil by Nikkin Steel Co., Ltd., thickness: 100 μm), a copper foil as a first spacer (“3EC-VLP” by Mitsui Mining & Smelting Co., Ltd., thickness: 18 μm), a copper foil to compose a metal foil laminate (“3EC-VLP” by Mitsui Mining & Smelting Co., Ltd., thickness: 18 μm), a resin-impregnated base material to compose the metal foil laminate, a copper foil to compose the metal foil laminate (“3EC-VLP” by Mitsui Mining & Smelting Co., Ltd., thickness: 18 mm), a copper foil as a first spacer (“3EC-VLP” by Mitsui Mining & Smelting Co., Ltd., thickness: 18 μm), an SUS foil as a second spacer (SUS foil by Nikkin Steel Co., Ltd., thickness: 100 μm), a copper foil to compose a first cushion material (“3EC-VLP” by Mitsui Mining & Smelting Co., Ltd., thickness: 18 μm), a polyimide sheet to compose the first cushion material (“KAPTONE® Film” by Toray-DuPont Co., Ltd., thickness: 300 μm), a copper foil to compose the first cushion material (“3EC-VLP”by Mitsui Mining & Smelting Co., Ltd., thickness: 18 μm), an SUS sheet as a partition plate (SUS301 with 1 mm thickness), an SUS sheet as a metal sheet (SUS304 with 5 mm thickness), and an aramid cushion as a second cushion material (aramid cushion by Ichikawa Techno-Fabrics Co., Ltd., thickness: 3 mm), in that order from the bottom.

Also, a high-temperature vacuum pressing machine (“KVHC-PRESS” by Kitagawa Seiki Co., Ltd., 300 mm length, 300 mm width) was used for hot pressing and integration of the second stack for 40 minutes under conditions with a temperature of 340° C. and a pressure of 5 MPa, under reduced pressure of 0.2 kPa, to obtain a metal foil laminate.

### Example 3

The heat-treated resin-impregnated base material was used to prepare a second stack having the structure shown in FIG. 3. Specifically, a second stack was prepared by laminating an aramid cushion as a second cushion material (aramid cushion by Ichikawa Techno-Fabrics Co., Ltd., thickness: 3 mm), an SUS sheet as a metal sheet (SUS304 with 5 mm thickness), an SUS sheet (SUS301 with 1 mm thickness), a copper foil to compose a first cushion material (“3EC-VLP” by Mitsui Mining & Smelting Co., Ltd., thickness: 18 μm), a polyimide sheet to compose the first cushion material (“KAPTONE® Film” by Toray-DuPont Co., Ltd., thickness: 200 μm), a copper foil to compose the first cushion material (“3EC-VLP” by Mitsui Mining & Smelting Co., Ltd., thickness: 18 μm), an SUS foil as a second spacer (SUS foil by Nikkin Steel Co., Ltd., thickness: 100 μm), a copper foil as a first spacer (“3EC-VLP” by Mitsui Mining & Smelting Co., Ltd., thickness: 18 μm), a copper foil to compose a metal foil laminate (“3EC-VLP” by Mitsui Mining & Smelting Co., Ltd., thickness: 18 μm), a resin-impregnated base material to compose the metal foil laminate, a copper foil to compose the metal foil laminate (“3EC-VLP” by Mitsui Mining & Smelting Co., Ltd., thickness: 18 μm), a copper foil as a first spacer (“3EC-VLP” by Mitsui Mining & Smelting Co., Ltd., thickness: 18 μm), an SUS foil as a second spacer (SUS foil by Nikkin Steel Co., Ltd., thickness: 100 μm), a copper foil to compose a first cushion material (“3EC-VLP” by Mitsui Mining & Smelting Co., Ltd., thickness: 18 μm), a polyimide sheet to compose the first cushion material (“KAPTONE® Film” by Toray-DuPont Co., Ltd., thickness: 200 μm), a copper foil to compose the first cushion material (“3EC-VLP” by Mitsui Mining & Smelting Co., Ltd., thickness: 18 μm), an SUS sheet as a metal sheet (SUS301 with 1 mm thickness), an SUS sheet (SUS304 with 5 mm thickness), and an aramid cushion as a second cushion material (aramid cushion by Ichikawa Techno-Fabrics Co., Ltd., thickness: 3 mm), in that order from the bottom.

Also, a high-temperature vacuum pressing machine (“KVHC-PRESS” by Kitagawa Seiki Co., Ltd., 300 mm length, 300 mm width) was used for hot pressing and integration of the second stack for 40 minutes under conditions with a temperature of 340° C. and a pressure of MPa, under reduced pressure of 0.2 kPa, to obtain a metal foil laminate.

### Comparative Example 1

The heat-treated resin-impregnated base material was used to form a second stack 9 by the same procedure as in Example 1 described above, except for omitting the SUS foils as the first cushion materials and second spacers. The second stack 9 was hot pressed and integrated to obtain a metal foil laminate.

Specifically, a second stack was prepared by laminating an aramid cushion as a second cushion material (aramid cushion by Ichikawa Techno-Fabrics Co., Ltd., thickness: 3 mm), an SUS sheet as a metal sheet (SUS304 with 5 mm thickness), an SUS sheet as a partition plate (SUS301 with 1 mm thickness), a copper foil as a first spacer (“3EC-VLP” by Mitsui Mining & Smelting Co., Ltd., thickness: 18 μm), a copper foil to compose a metal foil laminate (“3EC-VLP” by Mitsui Mining & Smelting Co., Ltd., thickness: 18 μm), a resin-impregnated base material to compose the metal foil laminate, a copper foil to compose the metal foil laminate (“3EC-VLP” by Mitsui Mining & Smelting Co., Ltd., thickness: 18 μm), a copper foil as a first spacer (“3EC-VLP” by Mitsui Mining & Smelting Co., Ltd., thickness: 18 μm), an SUS sheet as a partition plate (SUS301 with 1 mm thickness), an SUS sheet (SUS304 with 5 mm thickness), and an aramid cushion as a second cushion material (aramid cushion by Ichikawa Techno-Fabrics Co., Ltd., thickness: 3 mm), in that order from the bottom.

Also, a high-temperature vacuum pressing machine (“KVHC-PRESS” by Kitagawa Seiki Co., Ltd., 300 mm length, 300 mm width) was used for hot pressing and integration of the second stack for 40 minutes under conditions with a temperature of 340° C. and a pressure of 5 MPa, under reduced pressure of 0.2 kPa, to obtain a metal foil laminate.

<Evaluation of Outer Appearance of Metal Foil Laminate>

For each of Examples 1, 2 and 3 and Comparative Example 1, the cross-section of the metal foil laminate was observed, and the metal foil was etched off and the surface condition of the resin-impregnated base material was visually observed.

As a result, in Comparative Example 1, irregularities and bending were seen in the metal foil laminate, and not only was the flatness of the metal foil laminate reduced, but the uniform condition of the liquid crystal polyester in the resin-impregnated base material was also damaged and the glass cloth was partially exposed. This can potentially result in problems with the insulating property when a circuit has been formed in the metal foil. In contrast, with Examples 1, 2 and 3, no irregularities or bending were observed in the metal foil laminates and the flatness of each of the metal foil laminates was improved, while a uniform condition was also maintained for the liquid crystal polyester in the resin-impregnated base material, and no sections of exposed glass cloth were found.

### INDUSTRIAL APPLICABILITY

The present invention can be applied for a wide range of purposes, including production of a metal foil laminate to be used as a material for a printed circuit board.

### EXPLANATION OF SYMBOLS

1: Metal foil laminate, 2: resin-impregnated base material (insulating base material), 3, 3A, 3B: first metal foils, 3a: matt surface, 3b: shine surface, 5, 5A, 5B: first spacers, 5a: matt surface, 5b: shine surface, 6, 6A, 6B: metal sheets, 7, 7A, 7B: second cushion materials, 8: first stack, 9: second stack, 10, 10A, 10B: partition plates, 11: hot press apparatus, 12: chamber, 13: door, 15: vacuum pump, 16: upper heating plate (heating plate), 16a: pressing side, 17: lower heating plate (heating plate), 17a: pressing side, 18, 18A, 18B: second spacers, 20, 20A, 20B: first cushion materials, 21, 21A, 21B: polytetrafluoroethylene sheets (resin sheets), 22, 22A, 22B, 23, 23A, 23B: second metal foils, 22a, 23a: matt surfaces, 22b, 23b: shine surfaces.

1. A method for producing a metal foil laminate comprising metal foils on both sides of an insulating base material, the method comprising:
a second stack-preparing step in which a second stack is prepared having a laminar structure wherein a first stack comprising an insulating base material sandwiched between a pair of first metal foils, a pair of first spacers, a pair of second spacers and a pair of first cushion materials in that order, is sandwiched between a pair of metal sheets and a pair of second cushion materials, in that order, and
a second stack-hot pressing step in which the second stack is hot pressed with a pair of heating plates in the direction of lamination.

2. The method for producing a metal foil laminate according to claim 1, wherein in the second stack-hot pressing step, the second stack is hot pressed under reduced pressure.

3. The method according to claim 1, wherein the first metal foil is a copper foil.

4. The method according to claim 1, wherein the first spacer is a copper foil or SUS foil.

5. The method according to claim 1, wherein the second spacer is a copper foil or SUS foil.

6. The method according to claim 1, wherein the metal sheet is an SUS sheet.

7. The method according to claim 1, wherein the second cushion material is an aramid cushion.

8. The method according to claim 1, wherein the insulating base material is a prepreg in which a liquid crystal polyester is impregnated into inorganic fibers or carbon fibers.

9. The method according to claim 8, wherein the liquid crystal polyester has solvent solubility and has a flow start temperature of 250° C. or higher.

10. The method according to claim 8, wherein the liquid crystal polyester is a liquid crystal polyester having structural units represented by formula (1), (2) and (3), the content of the structural unit represented by formula (1) being 30-45 mol %, the content of the structural unit represented by formula (2) being 27.5-35 mol % and the content of the structural unit represented by formula (3) being 27.5-35 mol %, with respect to the total content of all of the structural units.
—O—Ar¹—CO— (1)
—CO—Ar²—CO— (2)
—X—Ar³—Y— (3)
(In the formulas, Ar¹ represents a phenylene or naphthylene group, Ar² represents a phenylene or naphthylene group or a group represented by formula (4), Ar³ represents a phenylene group or a group represented by formula (4), and X and Y each independently represent O or NH. The hydrogens of the groups represented by Ar¹, Ar² and Ar³ may each independently be replaced by halogen atoms, alkyl groups or aryl groups.)
—Ar¹¹—Z—Ar¹²— (4)
(In the formula, Ar¹¹ and Ar¹² each independently represent a phenylene or naphthylene group, and Z represents O, CO or SO₂.)

11. The method according to claim 10, wherein either or both X and Y of the structural unit represented by formula (3) are NH.

12. The method according to claim 1, wherein the first cushion material is a cushion material comprising a resin sheet sandwiched between a pair of second metal foils.

13. The method according to claim 12, wherein the second metal foil is a copper foil.

14. The method according to claim 12, wherein the second metal foil is provided with a matt surface, and is in contact with the resin sheet at the matt surface.

15. The method according to claim 12, wherein the resin sheet is a polytetrafluoroethylene sheet, aramid sheet, polyetherimide sheet, polyimide sheet or liquid crystal polymer sheet.

16. A method for producing a metal foil laminate comprising metal foils on both sides of an insulating base material, the method comprising:
a second stack-preparing step in which a second stack is prepared having a laminar structure wherein a multilayer structure in which a plurality of first stacks, each comprising an insulating base material sandwiched between a pair of first metal foils, a pair of first spacers, a pair of second spacers and a pair of first cushion materials in that order, and layered via partition plates in the direction of lamination, are sandwiched between pairs of metal sheets and pairs of second cushion materials, in that order, and
a second stack-hot pressing step in which the second stack is hot pressed with a pair of heating plates in the direction of lamination.
